(19) United States
(12) Patent Application Publication
(10) Pub. No.: US 2026/0351648 A1
(43) Pub. Date: Nov. 5, 2026

(54) SUPPRESSING CROSSOVER IN NON-AQUEOUS REDOX FLOW BATTERIES WITH POLYETHYLENE-BASED ANION EXCHANGE MEMBRANES

(71) Applicants: Shelley MINTEER, Salt Lake City, UT (US); Zayn k. RHODES, Salt Lake City, UT (US); Adam MILAM, Salt Lake City, UT (US); Emily CARROLL, Salt Lake City, UT (US); Geoffrey W. COATES, Ithaca, NY (US); Cheyenne R. PELTIER, Ithaca, NY (US); Alexandra J. MACBETH, Ithaca, NY (US); UNIVERSITY OF UTAH RESEARCH FOUNDATION, Salt Lake City, UT (US)

(72) Inventors: Shelley Minteer, SALT LAKE CITY, UT (US); Zayn K. Rhodes, SALT LAKE CITY, UT (US); Adam Milam, SALT LAKE CITY, UT (US); Emily Carroll, SALT LAKE CITY, UT (US); Geoffrey W. Coates, Ithaca, NY (US); Cheyenne R. Peltier, Ithaca, NY (US); Alexandra J. Macbeth, Ithaca, NY (US)

(21) Appl. No.: 18/997,437

(22) PCT Filed: Jul. 20, 2023
(86) PCT No.: PCT/US23/28285

§ 371 Date: Jan. 21, 2025

Related U.S. Application Data
(60) Provisional application No. 63/391,162, filed on Jul. 21, 2022.

(51) Int. Cl. H01M 8/18

(52) U.S. Cl. CPC H01M 8/188

(57) ABSTRACT

Non-aqueous redox flow batteries (NARFB) including a cation (e.g., trimethylammonium (“TMA”)) functionalized polyethylene or other polymeric membrane for mitigating electrolyte crossover. Such a battery can exhibit greater than 99%, or even 99.99% average capacity retention per cycle, with at least 50%, or even at least 85% total capacity retention through 1000 charge/discharge cycles. The trimethylammonium (TMA) or other cation functionalized membrane can be formed from copolymerized cycloalkene polymerizable components, e.g., where the copolymerized cycloalkene polymerizable components comprise a trimethylammonium or other quaternary ammonium substituted cycloalkene polymerizable component and a neutral or unsubstituted cycloalkene polymerizable component in a molar ratio of from 1:1 to 1:20, or 1:1 to 1:10, or 1:2 to 1:6.

### CROSS-REFERENCE TO RELATED APPLICATIONS

This application claims priority to and the benefit of U.S. Provisional Patent Application Ser. No. 63/391,162 entitled SUPPRESSING CROSSOVER IN NON-AQUEOUS REDOX FLOW BATTERIES WITH POLYETHYLENE-BASED ANION EXCHANGE MEMBRANES, filed Jul. 21, 2022 which is herein incorporated by reference in its entirety.

### STATEMENT REGARDING FEDERALLY SPONSORED RESEARCH OR DEVELOPMENT

This invention was made with government support under DE-AC02-06CH11357 awarded by the U.S. Department of Energy. The government has certain rights in the invention.

### FIELD OF THE INVENTION

The present invention generally relates to redox flow batteries.

### BACKGROUND

Redox flow batteries (RFBs) are a promising solution to grid-scale energy storage that utilize solvated redox-active species to store charge. These electrolytes are flowed over stationary electrodes during charge and discharge cycling. However, solubilizing the charge storage species allows for their crossover through the separating membrane, causing electrolyte mixing which leads to capacity fade and battery failure.

As such, there is a continuing need for improved configurations for RFBs that would address the problems of electrolyte mixing, battery cycle life, and the like.

### SUMMARY

In an aspect, the present disclosure describes trimethylammonium-or other cation functionalized polyethylene or other polymer membranes in RFB cells to address membrane swelling in organic solvent and maintain high ion conduction. Testing data shows unprecedented results with 99.99% average capacity retention per cycle and 88% total capacity retention through 1000 charge/discharge cycles with high efficiency and low crossover, as compared to a commercially available comparative membrane often used in non-aqueous RFB (“NARFB”) studies, which retained only 36% total capacity after 1000 cycles. The present disclosure represents an important step in developing and understanding anion exchange membranes (“AEMs”) as separators for non-aqueous redox flow batteries (“NARFBs”) and other electrochemical systems employing organic solvents.

In an embodiment, a non-aqueous redox flow battery (“NARFB”) is provided, including a pair of stationary electrodes including a first electrode and a second electrode. A non-aqueous anolyte is provided, for cycling through a cell defined by the NARFB, so as to contact the first electrode in a first cell portion (e.g., anode chamber). A non-aqueous catholyte is also provided, for cycling through a cell defined by the NARFB, so as to contact the second electrode in a second cell portion (e.g., cathode chamber). The first and second cell portions containing the anolyte and catholyte respectively are separated from one another by a membrane, where the membrane comprises a cation functionalized polyethylene or other polymeric membrane for mitigating crossover of the anolyte into the second cell portion and for mitigating crossover of the catholyte into the first cell portion.

Another exemplary embodiment is directed to a non-aqueous redox flow battery including a pair of stationary electrodes including a first electrode and a second electrode, a non-aqueous anolyte which is cycled through the NARFB so as to contact the first electrolyte in a first cell portion (anode chamber), and a non-aqueous catholyte which is cycled through the NARFB so as to contact the second electrode in a second cell portion (cathode chamber). The first and second cell portions containing the anolyte and catholyte respectively are separated from one another by a membrane, which comprises a trimethylammonium (“TMA”) or other functionalized polyethylene or other copolymer membrane for mitigating electrolyte crossover of the anolyte into the second cell portion, and for mitigating crossover of the catholyte into the first cell portion. By way of example, the non-aqueous carrier included in the anolyte and/or catholyte compositions can include an acetonitrile organic solvent.

In any of the described embodiments, the cation functionalized polyethylene or other polymer membrane comprises any of a variety of cations. While trimethylammonium (TMA) is a suitable example, others may include a variety of other cations, as will be apparent to those of skill in the art, such as an imidazole, a phosphonium, triaminocyclopropenium, or a quaternary ammonium other than TMA (e.g., any of the alkyl groups may be from C1-C20).

In any of the described embodiments, the membrane may comprise polyethylene, or another polymeric semi-crystalline polymeric hydrocarbon material, such as isotactic polypropylene.

In any of the described embodiments, the catholyte comprises (ferrocenylmethyl)trimethylammonium (“FcN”). Other catholytes capable of charging and discharging through a RFB, and exhibiting the desired solubility may additionally or alternatively be used. Non-limiting examples of such include phenathiazines, and/or derivatives of 2,2,6,6-tetramethylpiperidine-1-oxyl (“TEMPO”).

In any of the described embodiments, the anolyte comprises methyl viologen (“MV”). Other anolytes capable of charging and discharging through a RFB, and exhibiting the desired solubility in a selected non-aqueous solvent may additionally or alternatively be used. Such materials will be apparent to those of ordinary skill in the art. Non-limiting examples of such include other viologens, quinones, and/or pyridiniums.

In any of the described embodiments, the counterion in the anolyte and/or catholyte comprises hexafluorophosphate.

In any of the described embodiments, the catholyte comprises (ferrocenylmethyl)trimethylammonium (“FcN”) hexafluorophosphate and/or the anolyte comprises methyl viologen (“MV”) hexafluorophosphate.

In any of the described embodiments, the cation functionalized polyethylene membrane comprises a polyethylene copolymer or other polymeric or copolymeric membrane, functionalized with trimethylammonium (TMA) or another suitable cation. In any of the described embodiments, the functionalized polyethylene or other polymeric or copolymer membrane is formed from copolymerized cycloalkene (e.g., cyclooctene) polymerizable components.

In any of the described embodiments, the copolymerized cycloalkene polymerizable components comprise the neutral or unsubstituted cycloalkene component (e.g. cis-cyclooctene) and a trimethylammonium or other cation substituted cycloalkene (e.g., cyclooctene) polymerizable component.

In any of the described embodiments, the trimethylammonium substituted cycloalkene polymerizable component comprises (Z)—N,N,N-trimethyl-1-(1-methylcyclooct-4-en-1-yl)methanaminium iodide (“CTMA”). Various other polymerizable cycloalkene components are of course also possible.

In any of the described embodiments, the neutral or unsubstituted cycloalkene polymerizable component comprises cyclooctene (e.g., cis-cyclooctene).

In any of the described embodiments, the copolymerized cycloalkene polymerizable components comprise a trimethylammonium or other cation substituted cycloalkene polymerizable component and a neutral or unsubstituted cycloalkene polymerizable component in a molar ratio of from 1:1 to 1:20, or from 1:1 to 1:10.

In any of the described embodiments, the copolymerized cycloalkene polymerizable components comprise a trimethylammonium or other cation substituted cycloalkene polymerizable component and a neutral or unsubstituted cycloalkene polymerizable component in a molar ratio of from 1:2 to 1:6, such as 1:2, 1:3, 1:4, 1:5 or 1:6, or any values therebetween.

In any of the described embodiments, the copolymerized cycloalkene polymerizable components comprise a trimethylammonium or other substituted cycloalkene polymerizable component and a neutral or unsubstituted cycloalkene polymerizable component in a molar ratio of from 1:3 to 1:6, or 1:4 to 1:6.

In any of the described embodiments, at least one of the non-aqueous anolyte or the non-aqueous catholyte compositions comprise acetonitrile as an organic solvent. Various other organic solvents may also be suitable for use, e.g., including but not limited to propylene carbonate and/or dimethylformamide (“DMF”).

In any of the described embodiments, the battery exhibits greater than 99%, at least 99.5%, at least 99.9%, at least 99.95%, or at least 99.99% average capacity retention per cycle.

In any of the described embodiments, the battery exhibits at least 50%, 55%, 60%, 65%, 70%, 75%, 80%, 85%, at least 86%, at least 87%, or at least 88% total capacity retention through 1000 charge/discharge cycles.

Features from any of the disclosed embodiments may be used in combination with one another, without limitation. This summary is provided to introduce a selection of concepts in a simplified form that are further described below in the detailed description. This summary is not necessarily intended to identify key or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE FIGURES

Various objects, features, characteristics, and advantages of the invention will become apparent and more readily appreciated from the following description of the embodiments, taken in conjunction with the accompanying drawings and the appended claims, all of which form a part of this specification. In the figures, like reference numerals may be utilized to designate corresponding or similar parts in the various figures, and the various elements depicted are not necessarily drawn to scale.

FIG. 1A provides a general schematic illustration of an NARFB, showing exemplary chemical structures of electrolytes as described in the examples, showing at left a methyl viologen anolyte (top, shown in a neutral state, bottom, shown in a charged state). At right is shown an exemplary ferrocene-NMe₃ catholyte (top, shown in a neutral state, bottom, shown in a charged state).

FIG. 1B schematically illustrates the problem of electrolyte crossover experienced in a RFB employing a FUMASEP FAPQ-375-PP membrane.

FIG. 1C schematically illustrates an RFB employing a trimethylammonium functionalized polyethylene membrane as described in the present disclosure, which minimizes crossover.

FIGS. 2A-2D show redox flow battery cell cycling data for various TMA-PE-x membranes as compared to the FUMASEP FAPQ membrane. More specifically, FIG. 2A shows Coulombic efficiency. FIG. 2B shows normalized discharge capacity for the TMA-PE-x membranes and the FUMASEP FAPQ membrane through 100 cycles. FIG. 2C shows a capacity vs potential plot for the FUMASEP FAPQ membrane after 50 and 100 cycles. FIG. 2D shows capacity vs potential plots for the TMA-PE-6 membrane after 50 and 100 cycles.

FIGS. 3A-3F show cyclic voltammograms (CVs) of the RFB electrolytes. More specifically, FIG. 3A shows CV of the catholyte before and after 100 cycles using the FUMASEP FAPQ membrane. FIG. 3B shows CVs of the catholyte after 100 cycles for the various TMA-PE-x membranes. FIG. 3C shows CV data zoomed in at −0.83 V vs Fc⁰/Fc⁺ showing the characteristic redox couple of methyl viologen (“MV”). FIG. 3D shows CV of the anolyte before and after 100 cycles with the FUMASEP FAPQ membrane. FIG. 3E shows CVs of the anolyte after 100 cycles for the various TMA-PE-x membranes. FIG. 3F shows CV data zoomed in at 0.22 V vs Fc⁰/Fc⁺ showing the characteristic redox couple of (ferrocenylmethyl)trimethylammonium (“FcN”).

FIGS. 4A-4F show redox flow battery cycling data for the FUMASEP FAPQ membrane and the TMA-PE-6 membrane after 1000 cycles. More specifically, FIG. 4A shows CVs of the anolyte solution from the RFB employing the FUMASEP FAPQ before and after 1000 cycles. FIG. 4B shows the capacity and efficiency vs cycle for 1000 cycles for the FUMASEP FAPQ membrane. FIG. 4C shows the capacity vs potential for selected cycles (100, 250, 500 and 1000) for the FUMASEP FAPQ membrane example. FIG. 4D shows CVs of the anolyte solution from the RFB employing TMA-PE-6 before and after 1000 cycles. FIG. 4E shows capacity and efficiency vs cycle for 1000 cycles for TMA-PE-6. FIG. 4F shows capacity vs potential for selected cycles (100, 250, 500 and 1000) for the TMA-PE-6 membrane example.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments, and is not necessarily intended to limit the scope of the claimed invention.

### I. INTRODUCTION

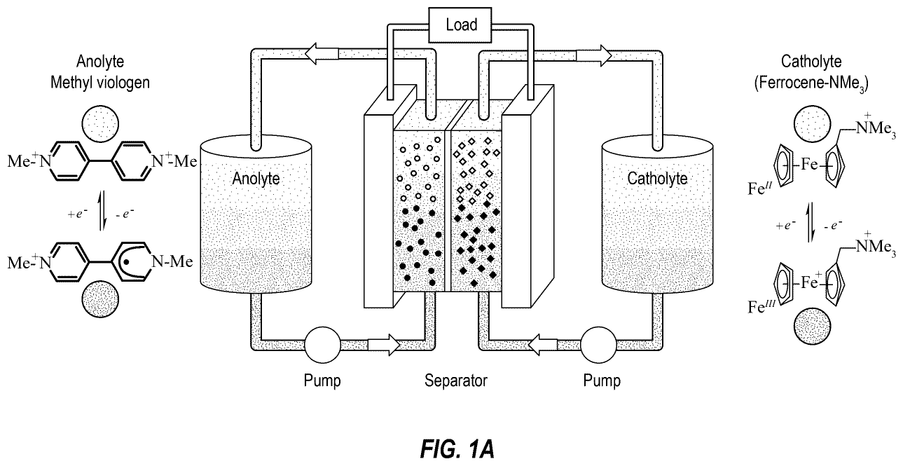

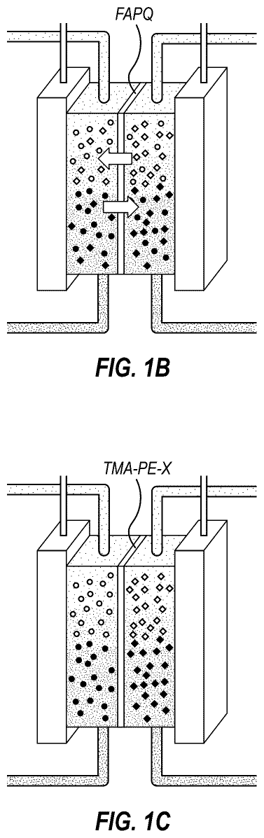

Greenhouse gasses generated from fossil fuel combustion create a major impact on global climate change. These fuel reserves are also rapidly being depleted, thus it becomes increasingly necessary to explore alternative energy generation strategies. Solar and wind power present enticing options, as these sources are naturally occurring and generally abundant. However, source intermittency prevents exclusive grid power supply from the elements. Large-scale energy storage technologies are required to create a consistent electrical energy supply to the grid, and redox flow batteries (RFBs) are a promising solution. In RFBs, redox-active species are solubilized in supporting electrolytes and maintained in bulk storage outside the electrochemical cell, as shown in FIG. 1A. Thus, energy (generally dependent on solution volume and concentration) and power (dependent on the electrode surface area in the cell) are effectively decoupled, allowing for battery tuning and scaling for the necessary application. However, by solubilizing the anode and cathode materials (anolyte and catholyte, respectively) these species are in frequent contact with the membrane separator between the stationary electrodes. This allows undesirable transport of these redox-active species through the separator, resulting in electrolyte mixing, membrane pore-clogging, and possible deleterious side reactions between electrolytes. This electrolyte crossover is consequential and impedes battery storage capacity and cell efficiency. Therefore, understanding and suppressing electrolyte crossover in RFBs is very important to harnessing their full potential.

Current strategies to address crossover are two-fold. The first involves the use of a porous size-exclusion separator, such as DARAMIC or CELGUARD, and use of high molecular weight redox active species (oligomers, polymers, and colloids), allowing for transport selectivity based upon steric bulk of electrolytes. This approach has been explored in the literature, both from a molecular and a membrane perspective and has proven effective at mitigating crossover. However, augmenting the bulk of the electrolytes decreases their intrinsic capacity and can introduce other drawbacks such as increased synthetic rigor and system complexity, decreased solubility, and slower free diffusion in solution. The second strategy is to employ permanently charged redox active small organic molecules (SOMs) as anolyte and catholyte species paired with an ion exchange membrane to minimize crossover through Coulombic repulsion (Donnan exclusion). While this combination shows promise in addressing crossover in aqueous RFBs, effective non-aqueous RFBs (NARFBs) utilizing ion exchange membranes remain elusive.

NARFBs, wherein organic solvents are employed to solubilize electrode species, present a particularly rich area of exploration with compounding reward. The solvent electrochemical window for many organic solvents, such as acetonitrile, is much higher than water (~5 V vs. ~1.5 V respectively) allowing for batteries with a much higher theoretical energy density. Ion exchange membranes specifically designed to inhibit crossover in these conditions are only recently being explored. For example, commercially available anion exchange membranes (“AEMs”) can swell or are soluble in organic solvents which can be important when processing the polymers into thin films via solvent casting. However, when used as a separator in a NARFB, any solubility or swelling of the membrane in the organic solvent employed in the NARFB promotes unwanted electrolyte crossover, as represented in FIG. 1B.

Employing a polymer backbone such as polyethylene (“PE”) (or perhaps another semi-crystalline hydrocarbon polymer such as isotactic polypropylene) that is insoluble in most organic solvents can help to mitigate electrolyte crossover by providing a barrier that neither dissolves nor swells substantially. By way of example, isotactic polypropylene may have a crystallinity of at about least 30%, and/or no more than about 60%, such as 30-60%. Unfunctionalized PE induces a high resistance in the cell as it is uncharged and thus permits little to no transport of counter ions (e.g., PF₆⁻) through the membrane. The present disclosure contemplates cation functionalized PE or similar membranes, e.g., functionalized with trimethylammonium (“TMA”) or other cations with varying cationic content to maximize conductivity while minimizing or preventing crossover. Such an exemplary configuration is shown schematically in FIG. 1C.

### II. EXEMPLARY NON-AQUEOUS REDOX FLOW BATTERIES

The present disclosure is thus directed to NARFBs comprising a pair of stationary electrodes including a first electrode and a second electrode, a non-aqueous anolyte which is cycled through the NARFB so as to contact the first electrode (anode) in a first cell portion (anode chamber). A non-aqueous catholyte is also cycled through the NARFB, so as to contact the second electrode (cathode) in a second cell portion (cathode chamber). The first and second cell portions containing the anolyte and catholyte respectively are separated from one another by a membrane, wherein the membrane comprises a cation functionalized PE or other polymeric membrane for mitigating crossover of the anolyte into the second cell portion and for mitigating crossover of the catholyte into the first cell portion.

In an embodiment, the stationary electrodes may be formed from any suitable material, such as carbon, or another suitable electrically conductive material that is stable within the non-aqueous solvent of the electrolyte anolyte and catholyte solutions. Non-limiting examples for electrode materials include carbon felt, carbon paper, carbon fiber, carbon nanotubes, glassy carbon, graphite (e.g., a graphite plate), any metallic electrically conductive electrode material, or other electrically conductive material.

In an embodiment, the non-aqueous anolyte and catholyte solutions may include an organic solvent, such as acetonitrile. A variety of other non-aqueous liquid solvent materials may alternatively or additionally be used. Such materials will be apparent to those of skill in the art. Non-limiting examples of other organic solvents include propylene carbonate and/or dimethylformamide (“DMF”). Combinations of various organic solvents can be used. As will be apparent, the anolyte and catholyte may be entirely or substantially free of water. Suitable organic solvents will provide good solubility of the selected anolyte and catholyte materials, within the selected organic solvent.

Any of a variety of soluble anolyte materials capable of charging and discharging may be used as the anolyte. An exemplary non-limiting exemplary component for the anolyte includes methyl viologen (“MV”). An exemplary methyl viologen, including its charged and discharged states is shown in Figure TA. Other anolytes capable of charging and discharging through a RFB, and exhibiting the desired solubility in a selected non-aqueous solvent may additionally or alternatively be used. Such materials will be apparent to those of ordinary skill in the art. Non-limiting examples of such include other viologens, quinones, and/or pyridiniums.

Any of a variety of soluble catholyte materials capable of charging and discharging may be used as the catholyte. An exemplary non-limiting exemplary component for the catholyte includes (ferrocenylmethyl)trimethylammonium (“FcN”). An exemplary (ferrocenylmethyl)trimethylammonium, including its charged and discharged states is shown in FIG. 1A. Other catholytes capable of charging and discharging through a RFB, and exhibiting the desired solubility may additionally or alternatively be used. Non-limiting examples of such include phenathiazines, and/or derivatives of 2,2,6,6-tetramethylpiperidine-1-oxyl (“TEMPO”).

By way of example, the anolyte and catholyte charged redox active species can be characterized as small organic molecules (SOM). For example, such charged species may have a molecular weight of less than about 500 g/mol, less than about 450 g/mol, less than about 400 g/mol, less than about 350 g/mol, or less than about 300 g/mol. Methyl viologen (C₁₂H₁₄N₂²⁺, for example, has a molecular weight of about 187 g/mol, while (ferrocenylmethyl)trimethylammonium (C₁₄H₂₀FeN⁺) has a molecular weight of about 259 g/mol.

The contemplated NARFBs include an anion exchange membrane (“AEM”). Such a membrane separator between the anolyte and catholyte may comprise polyethylene. Various other polymeric materials that exhibit little or no swelling or solubility within the non-aqueous cell medium may additionally or alternatively be used, as will be appreciated by those of skill in the art. An example of such may include isotactic polypropylene, or another semi-crystalline hydrocarbon polymer material. While some polypropylenes (e.g., isotactic polypropylene) may be suitable in some embodiments, at least some polypropylene materials are not suitable for use, and are excluded, e.g., particularly when using acetonitrile as the organic solvent cell medium. For example, the FUMASEP FAPQ-375-PP membrane is a membrane based on polypropylene, although this membrane does not provide good mitigation of crossover in such a combination, as shown in the examples. Polypropylene may provide suitable results when used with other organic solvents, and/or when used in an isotactic form.

Because unfunctionalized polyethylene permits little to no transport of the counterions employed in the present examples (e.g., hexafluorophosphate “PF₆⁻”), it is important that the polyethylene (or a similar membrane) be functionalized with one or more cationic functional groups, to provide for the desired transport of counterions through the membrane.

In an embodiment, the membrane is functionalized with trimethylamine (“TMA”). Other cationic functionalizations may additionally or alternatively be possible, e.g., such as other amines, imidazoles, phosphoniums, triaminocyclopropenium, or a quaternary ammonium other than TMA (e.g., any of the alkyl groups may be from C1-C20). Various non-limiting cationic nitrogen containing examples are shown hereafter. In an embodiment, any such cationic functional groups are relatively small, e.g., having a molecular weight of no more than 1000, no more than 900, no more than 800, no more than 700, no more than 600, no more than 500, no more than 400, no more than 300, no more than 200, no more than 150, no more than 100, or no more than 80 g/mol. By way of example, TMA has a molecular weight of about 59 g/mol. Generally speaking relatively smaller functional groups are likely to exhibit better performance, although some suitable examples could include two or more cations in a single monomer, where such monomer may have a relatively higher molecular weight, but may perform similarly to a lower molecular weight embodiment, with only one functional group in the monomer.

The cationic functional groups may be included within the polymer backbone in any desired concentration. That said, increasing the concentration of the cationic functional groups results in increased crossover, as shown in the Examples. By way of example, in an embodiment, the molar ratio of such cationic functional groups to aliphatic CH₂ groups in the polyethylene or similar hydrocarbon chain may be from 1:10 to 1:100, from 1:15 to 1:80, from 1:20 to 1:60, or from 1:25 to 1:40.

In an example, the polyethylene or other backbone with the cationic functional groups may be formed through a copolymerization of cycloalkene components (e.g., cyclic components where at least one of the monomers is a cyclic ammonium polymerizable component). At least one of the cycloalkene components may include the desired cationic functional group, which becomes incorporated into the polymer backbone, during polymerization. For example, a cycloalkene such as cyclooctene (e.g., cis-cyclooctene “COE”) may be copolymerized with a cycloalkene (e.g., cyclooctene) that includes a trimethylammonium or other cationic substituent. In an embodiment, the two cycloalkene components may be similar, other than the inclusion of the cationic substitution in one of the components. In another embodiment, they may exhibit other differences (e.g., additional branches, additional substitutions, different number of carbons in the ring, the presence of heteroatoms, etc). By way of example, (Z)—N,N,N-trimethyl-1-(1-methylcyclooct-4-en-1-yl)methanaminium (e.g., an iodide or other halide salt thereof) (“CTMA”) is such an exemplary trimethylamine substituted cyclooctene. By way of example, CTMA and COE have the respective structures shown below.

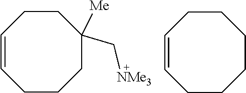

As each of the shown structures includes an 8 member cycloalkene ring, upon polymerization at a 1:1 ratio there will be 1 trimethylammonium group, for 16 CH₂ groups. Where the polymerization ratio of COE to CTMA is increased to 2:1, the ratio becomes 1 trimethylammonium group to 24 CH₂ groups. At a polymerization ratio of COE to CTMA of 3:1, the ratio becomes 1 trimethylammonium group to 32 CH₂ groups. At a polymerization ratio of COE to CTMA of 4:1, the ratio becomes 1 trimethylammonium group to 40 CH₂ groups. At a polymerization ratio of COE to CTMA of 5:1, the ratio becomes 1 trimethylammonium group to 48 CH₂ groups. At a polymerization ratio of COE to CTMA of 6:1, the ratio becomes 1 trimethylammonium group to 56 CH₂ groups. Other ratios are of course also possible. While in some embodiments the cation is copolymerized with unsubstituted COE, it will be appreciated that one could also copolymerize with a substituted but still neutral COE or other neutral cycloalkene. Such embodiments are within the contemplated scope of the present disclosure.

As shown in the examples, at a COE:CTMA ratio of 6:1, crossover across the membrane is essentially eliminated. That said, at such a low cation concentration, counterion transport is also significantly reduced. As such, in an embodiment, COE:CTMA ratios of 2:1 to 5:1, or 3:1 to 5:1, or 3:1 to 4:1 may be advantageous in balancing mitigation of crossover, while also providing sufficient counterion transport across the membrane.

More broadly, the ratio of the trimethylammonium or other cation substituted polymerizable component to unsubstituted or neutral polymerizable component may be in a molar ratio of from 1:1 to 1:20, or from 1:1 to 1:10, or from 1:2 to 1:6, or from 1:3 to 1:6. For example, while performance may typically be lower at higher ratios all else being equal, a higher ratio could be used, e.g., a dicationic functionalized monomer at a 1:10 ratio may provide functionality similar to a 1:5 molar ratio.

The NARFB may exhibit greater than 99%, at least 99.5%, at least 99.9%, at least 99.95%, or at least 99.99% average capacity retention per cycle. Such excellent capacity retention allows for high capacity retention through hundreds, even thousands of cycles. For example, The NARFB may exhibit at least 50%, 55%, 60%, 65%, 70%, 75%, or 85% total capacity retention through 1000 charge/discharge cycles. By way of comparison, an otherwise similar NARFB, but using a FUMASEP FAPQ-375-PP membrane achieves less than 40% total capacity retention through 1000 charge/discharge cycles.

A variety of non-limiting examples of various cation substituted structures that could be used for such copolymerization are shown below. Analogous neutral or unsubstituted structures will be apparent to those of skill in the art, which could be copolymerized with any suitable cation substituted structure. Various other examples of neutral and cation substituted monomers will be apparent to those of skill in the art, in light of the present disclosure.

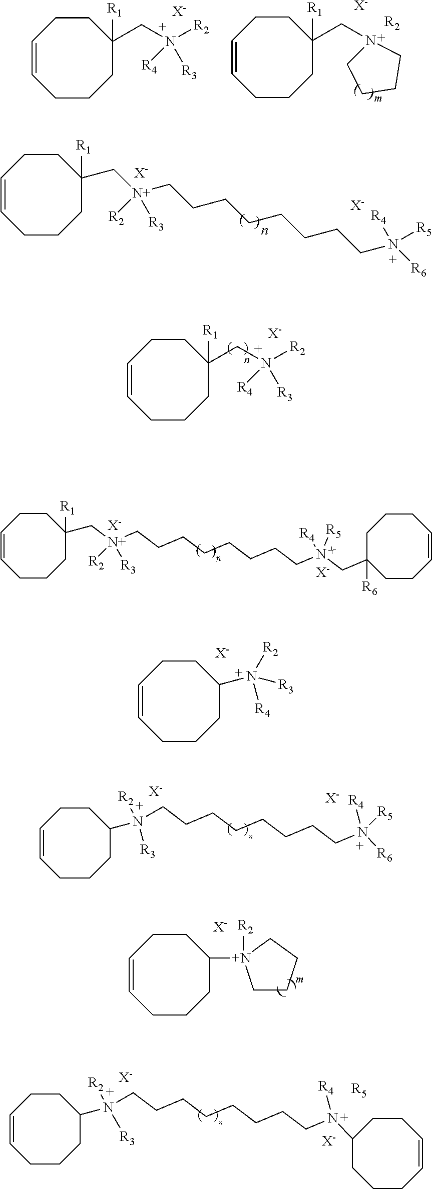

Within any such structures n may be a C1-C20 group, with possible heteroatoms in any units between the polymerizable unit and the cation. RI may represent hydrogen or a C1-C20 group, with possible heteroatoms in the chain. R2-R6 may represent C1-C20 with possible heteroatoms in the chain. m may represent 0-2 carbons, for ring sizes of 5-7, with possible hetero atoms. X represents a counterion, such as, but not limited to Cl, Br, I, PF₆, SbF₆, BF₄, and/or bis(trifluoromethane)sulfonimide (“TFSI”).

A variety of other cations are possible, for example, any of those disclosed in WO/2010/138958 and U.S. Pat. No. 9,493,397, each of which is herein incorporated by reference in its entirety.

As apparent from the examples, the degree of polymerization also provides a “lever” that can be tuned, e.g., as easily as the cationic to neutral monomer ratio. While the illustrated example used a degree of polymerization of 1000, it will be apparent that the range of polymerization may more generally range from 200 to 5000, or from 500 to 2000, or from 750 to 1500.

### III. EXAMPLES

A series of PE-based AEMs with variable cationic content were tested in an RFB cell with a standard cell and standard electrolyte pair. Crossover percentages were obtained via post battery cycling analysis of the electrolytes. The results were then compared to those obtained with a commercial membrane often used in NARFB studies: FUMASEP FAPQ-375-PP (FAPQ). Finally, the highest performing membrane and FAPQ were cycled for 1000 cycles to measure long-term performance and crossover.

### Example 1

In this example, AEMs with various cationic content were fabricated. Cation-functionalized PE can be achieved through the ring-opening metathesis polymerization (ROMP) of cis-cyclooctene (“COE”) with a cation-functionalized cyclooctene monomer, followed by hydrogenation of the resulting polymer. This strategy was employed to form AEMs for RFBs by copolymerizing COE with (Z)—N,N,N-trimethyl-1-(1-methylcyclooct-4-en-1-yl)methaniminium iodide (CTMA)) followed by hydrogenation to afford a PE backbone with pendant TMA groups. Table 1 shows details of the synthesized membranes. CTMA can be synthesized or obtained commercially. TMA was selected for incorporation into the PE backbone as it is the smallest functionality that could be incorporated into the PE-based AEM, allowing for a higher ion-exchange capacity (IEC) and reduced swelling compared to AEMs containing larger cations.

Table 1 shows the various AEMs that were formed, with cationic TMA content varying from a CTMA:COE ratio of 1:2 to 1:6.

Synthesis was carried out using the process shown below.

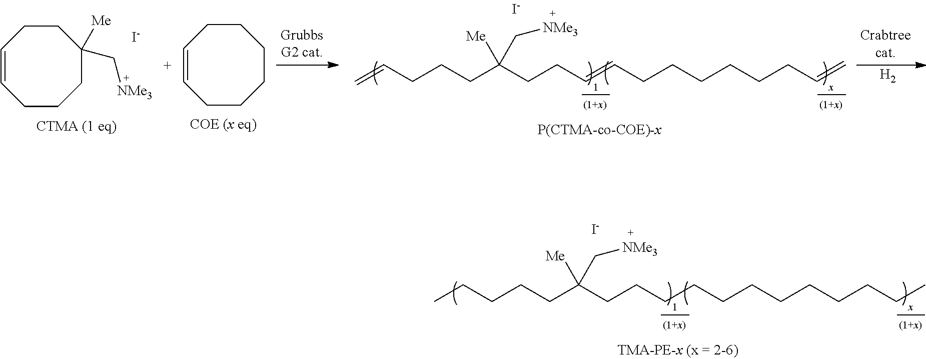

TABLE 1

| | | | | | | MeCN | MeCN |
|---|---|---|---|---|---|---|---|
| | | IEC | IEC | IEC | | Uptake | Uptake |
| | | (Theo) | (NMR) | (Titration)ª | Thick- | (I⁻ | (PF₆⁻ |
| Mem- | x eq | (mmol | (mmol | (mmol | ness | Form) | Form) |
| brane | COE | I⁻/g) | I⁻/g) | I⁻/g) | (μm) | (wt %)ª | (wt %)ª |
| FAPQ | N/A | N/A | N/A | N/A | 68 − 82^{b} | 33 ± 4 | 44 ± 6 |
| TMA- | 2 | 1.84 | 1.85 | 1.81 ± 0.13 | 80 ± 6 | 16 ± 5 | 27 ± 3 |
| PE-2 | | | | | | | |
| TMA- | 3 | 1.53 | 1.56 | 1.55 ± 0.05 | 65 ± 4 | 9 ± 4 | 24 ± 5 |
| PE-3 | | | | | | | |
| TMA- | 4 | 1.31 | 1.32 | 1.35 ± 0.07 | 74 ± 5 | 4 ± 3 | 18 ± 4 |
| PE-4 | | | | | | | |
| TMA- | 5 | 1.14 | 1.15 | 1.17 ± 0.10 | 74 ± 7 | 3 ± 8 | 11 ± 5 |
| PE-5 | | | | | | | |
| TMA- | 6 | 1.02 | 1.02 | 1.00 ± 0.06 | 78 ± 5 | 2 ± 5 | 8 ± 4 |
| PE-6 | | | | | | | |

^{a}Errors calculated to a 95% confidence level with values measured in triplicate.
^{b}Values obtained from the from theliterature.

The monomer feed ratio (x:1) of COE:CTMA was altered to achieve membranes with a range of cationic contents, and thus a range of IECs (1.02-1.84), with the total olefin:catalyst ratio held constant to target the same degree of polymerization (DP=1000). The cationic content was determined by integrating the ¹H NMR spectra of TMA-functionalized poly(cyclooctene) (P(CTMA-co-COE)-x), as the hydrogenated polymers (TMA-PE-x) are not easily solubilized. The TMA-PE-x polymers were pressed into thin films with thicknesses ranging from 54-80 μm, comparable to FAPQ (68-82 μm). Titrations were performed on a TMA-PE-x film from each x:1 ratio (2:1-6:1) as another method of determining the IEC, as reported in Table 1.

Acetonitrile uptake (wt %) was determined for each TMA-PE-x membrane for each x:1 ratio, as a low uptake of the electrolyte solvent is desired to prevent crossover in RFBs. It was observed that acetonitrile uptake increased with increasing cation content in both the I⁻ and PF₆⁻ forms (see Table 1). All TMA-PE-x membranes demonstrated a lower acetonitrile uptake than FAPQ and retained their original, flat shape during an acetonitrile soak, while FAPQ curled up instantly when soaked in acetonitrile. There was no significant trend observed between cationic content and the crystallinity of the polymer or the dimensional swelling of the films (change in length).

Grubbs II catalyst (G2, ≥97.0%) was used as purchased from Sigma-Aldrich. cis-cyclooctene (COE, 95%) and methanol used for polymerization were purchased from Sigma-Aldrich, dried over CaH2, distilled, and degassed before use. Dichloromethane (“DCM”) was dried over an alumina column followed by degassing by three freeze-pump-thaw cycles before use. Benchtop DCM and MeOH were purchased from Fisher Scientific and used as received. Crabtree catalyst was used as purchased from Strem. Deuterated NMR solvents (CDCl₃, CD₂Cl₂, CD₃OD) were purchased from Cambridge Isostope Laboratories (CIL). SiliaMets DMT (Dimeraptotriazine) was purchased from SiliCycle. For electrolyte synthesis and ion exchange, 4,4′-bipyridine, chloroacetic acid, dimethyl formamide, dichloromethane, ammonium hexafluorophosphate (NH₄PF₆), (ferrocenylmethyl)dimethylamine, and chloromethane were purchased from Sigma-Aldrich and used as received. For RFB testing, acetonitrile was purchased from Acros Organics and used as received and potassium hexafluorophosphate (KPF₆) was purchased from Oakwood Chemical and used as received.

The poly(CTMA-co-COE)-x polymers for the various AEMs shown in Table 1 were synthesized as follows. Grubbs II catalyst (G2) was added to a dram vial in a dry nitrogen-filled MBraun UniLab drybox. To a vial, (Z)—N,N,N-trimethyl-1-(1-methylcyclooct-4-en-1-yl)methanaminium iodide (CTMA), 0.9 mL DCM, 0.1 mL MeOH, cis-cyclooctene (COE), and a small stir bar were added to produce a monomer solution that was stirred vigorously. 0.1 mL DCM was added to the G2 to form a catalyst solution which was then added to the vigorously stirred monomer solution. The pink reaction mixture gelled slightly, and the vial was capped, removed from the glovebox, wrapped with parafilm, and set to stir at 22 °C for 16 hours. 2 mL DCM and 1 mL MeOH were added to dilute the polymer solution. 0.2 mL ethylvinylether was then added to quench the polymerization followed by 100 mg SiliaMets DMT as a metal scavenger. The reaction mixture was allowed to stir for 1 hour before it was filtered through cotton into a 20 mL scintillation vial. The polymer solution was concentrated under reduced pressure and the resulting light brown polymer was dried under vacuum. The polymer was washed three times with 10 mL acetone to remove any residual monomer and was dried under vacuum. The specific amounts of each reagent used for each x:1 ratio (COE:CTMA) are described below.

P(CTMA-co-COE)-2: Catalyst solution: 0.8 mg Grubbs II catalyst (G2) (1×10⁻³ mmol, 1 equiv), 0.1 mL DCM. Monomer solution: 107.7 mg CTMA (0.3331 mmol, 333.1 equiv), 0.9 mL DCM, 0.1 mL MeOH, 86.7 μL COE (0.667 mmol, 667 equiv).

P(CTMA-co-COE)-3: Catalyst solution: 0.8 mg Grubbs II catalyst (G2) (1×10⁻³ mmol, 1 equiv), 0.1 mL DCM. Monomer solution: 80.8 mg CTMA (0.250 mmol, 250 equiv), 0.9 mL DCM, 0.1 mL MeOH, 97.5 μL COE (0.750 mmol, 750 equiv).

P(CTMA-co-COE)-4: Catalyst solution: 0.8 mg Grubbs II catalyst (G2) (1×10⁻³ mmol, 1 equiv), 0.1 mL DCM. Monomer solution: 64.6 mg CTMA (0.200 mmol, 200 equiv), 0.9 mL DCM, 0.1 mL MeOH, 104 μL COE (0.800 mmol, 800 equiv).

P(CTMA-co-COE)-4-(1-5): The polymerization was scaled up to produce multiple films from one polymer batch. Catalyst solution: 3.4 mg Grubbs II catalyst (G2) (4.0×10⁻³ mmol, 1.0 equiv), 0.4 mL DCM. Monomer solution: 258.6 mg CTMA (0.7999 mmol, 799.9 equiv), 0.9 mL DCM, 0.1 mL MeOH, 416 μL COE (3.20 mmol, 3.20×10³ equiv). After 16 h at 22 °C, 8 mL DCM and 2 mL MeOH were added to dilute the polymer solution. 0.8 mL ethylvinylether was then added to quench the polymerization followed by 400 mg SiliaMets DMT as a metal scavenger.

P(CTMA-co-COE)-5: Catalyst solution: 0.8 mg Grubbs II catalyst (G2) (1×10⁻³ mmol, 1 equiv), 0.1 mL DCM. Monomer solution: 54.0 mg CTMA (0.167 mmol, 167 equiv), 0.9 mL DCM, 0.1 mL MeOH, 108.3 μL COE (0.8334 mmol, 833.4 equiv).

P(CTMA-co-COE)-6: Catalyst solution: 0.8 mg Grubbs II catalyst (G2) (1×10⁻³ mmol, 1 equiv), 0.1 mL DCM. Monomer solution: 46.5 mg CTMA (0.144 mmol, 144 equiv), 0.9 mL DCM, 0.1 mL MeOH, 111 μL COE (0.854 mmol, 854 equiv).

The hydrogenation procedure for each sample was generally carried out as follows. The P(CTMA-co-COE)-x polymer (115-180 mg) was transferred to an oven-dried glass Parr cylinder containing a stir bar. 9 mL DCM and 1 mL MeOH was added to the cylinder and the mixture was allowed to stir until the polymer was completely dissolved. In a dry nitrogen-filled MBraun UniLab drybox, 1.6 mg Crabtree's catalyst (2.0×10⁻³ mmol) was weighed into a dram vial and was then removed from the glovebox. 1 mL DCM was then added to form a catalyst solution, which was then added to the stirring polymer solution. The cylinder was sealed in a Parr reactor which was then charged with 700 psi H₂, vented to 200 psi three times to purge the reactor, then charged back up to 700 psi H₂. The reaction was set to stir at 600 rpm and 95 °C for 16 hours. The reactor was then allowed to cool for 1 hour before it was vented and the contents of the cylinder were transferred to a 20 mL scintillation vial. The polymer solution was concentrated under reduced pressure then dried under vacuum. 5 mL acetone was added to the polymer to aid in scraping it from the sides of the vial and the polymer was dried under vacuum, producing each of the various TMA-PE-x polymers.

The produced TMA-PE-x polymers were processed into thin-film membranes as follows. Each TMA-PE-x polymer was placed between two Teflon sheets, which was placed between two stainless-steel plates. The plates were placed into a 4120 hydraulic Carver press and were heated to 140 °C at 3.6 metric tons for 5 min. Water was then run through the Carver press to cool the polymer film to 22 °C. This process was performed twice for each film. The thickness of each film was determined using a digital micrometer (±0.001 mm).

Various measurements reported in Table 1 and other obtained measurements were determined as follows.

To determine ion exchange capacity (IEC) concentration, membrane strips weighing 1.5-7.0 mg were soaked in 20 mL saturated NaCl_{(aq)} solution for 16 h followed by two 1-hour washes in saturated NaCl_{(aq)} solution. The strips were then washed in three 20 mL DI water washes for 30 minutes each to remove any residual NaCl. The strips were then soaked in 10 mL 0.1 M NaNO_{3(aq)} for at least 24 hours before the solution was transferred to a 100 mL beaker followed by 10 drops of K₂CrO₄ solution as an indicator. The solution was titrated with 1×10⁻³ M AgNO_{3(aq)} until the solution turned light orange from bright yellow. The titration was repeated in triplicate for each membrane tested. equation (1) was used to calculate the IEC in chloride form (mmol Cl⁻/g). The IEC in the Cl⁻ form was converted into the IEC in the I⁻ form (mmol I⁻/g) using equation (2) so that the titration could be compared to the theoretical and NMR IECs.

$$IEC ( {Cl}^{-} ) = \frac{mmol {Cl}^{-}}{membrane mass} \qquad ( 1 )$$

$$IEC ( {I}^{-} ) = \frac{IEC ( {Cl}^{-} )}{( 1 + 0.0915 ( EIC ( {Cl}^{-} ) ) )} \qquad ( 2 )$$

To determine acetonitrile uptake and swelling measurements, strips of membrane (2-10 mg each) were immersed in 20 mL anhydrous acetonitrile at 22 °C for 16 h. The strips were then gently blotted with a Kimwipe to remove excess acetonitrile off the surface. The strips were weighed, and their length was measured before they were added to centrifuge tubes, which were placed in a drying tube. Full vacuum was applied within the drying tube as it was heated to 70 °C for 6 h. The strips were then removed from the drying tube, weighed and their length measured. The acetonitrile uptake was determined using equation (3) and the degree of dimensional swelling was determined using equation (4). The experiment was performed in triplicate for each membrane tested.

$$Uptake ( wt \% ) = 100 ( \frac{Wet mass - dry mass}{dry mass} ) . \qquad ( 3 )$$

$$Swelling ( Δ L \% ) = 100 ( \frac{Wet length - dry length}{dry length} ) . \qquad ( 4 )$$

To determine differential scanning calorimetry (DSC) measurements, a Mettler Toledo Polymer DSC instrument fitted with a TS0801R0 Sample Robot was used. Crimped aluminum pans containing 2-8 mg of membrane were prepared for each run. Samples were first cooled to −70 °C, maintained at −70 °C for 10 min then heated to 200 °C and maintained at the temperature for 10 min to erase any thermal history. The samples were then cooled to −70 °C and heated to 200 °C again. The samples were cooled at a rate of 10 °C/min under a nitrogen atmosphere. The crystallization temperature (Tc) and percent crystallinity were obtained from the second cooling and the melting temperature (Tm) was obtained from the second heating cycles, respectively, using the STARe software. The percent crystallinity was determined by comparing the enthalpy of crystallization (J/g) of the sample to the literature value of 293 J/g for high density polyethylene (HDPE).

To determine nuclear magnetic resonance (NMR) measurements, ¹H NMR spectra were collected in deuterated solvents on a Varian INOVA 400 or a Bruker 500 at 22 °C with shifts reported relative to the residual solvent peaks (CD₂Cl₂ (5.32 ppm (¹H) or CDCl₃ (7.26 ppm (¹H)). The cation monomer incorporation (x:1 ratio) was determined by calculating the ratio of the total aliphatic region (e.g., CH₂) to the cationic region. This was done by setting the cation peaks ~3.4 ppm to integrate to 11H which is the total number of protons on the cationic moiety, thus setting y in equation (5) to 1. The IEC in I⁻ form was calculated by plugging the x value found from equation (5) into equation (6) 110.2 and 323.3 are the molecular weights of the monomers COE and CTMA, respectively.

$$Allphatic H integration = 12 x + 13 y \qquad ( 5 )$$

$$IEC ( {I}^{-} ) = \frac{1}{( 110.2 x + 323.3 )} \qquad ( 6 )$$

The membrane ion exchange procedure was performed as follows. Prior to RFB cell testing, membranes were ion exchanged from the I⁻ form to the PF₆⁻ form by soaking in saturated NH₄PF_{6(aq)}. The membranes were soaked 3 times for 12 hours and rinsed with DI water after each soak. Each membrane was then dried overnight in a vacuum oven at 30 °C to remove excess water.

Redox flow battery tests were conducted using a zero-gap flow cell prototype. The cell of the device included polypropylene flow fields sealed with Kalrez O-rings backing interdigitated graphite flow plates with 2 pieces of non-woven carbon paper on each side as electrode materials with the membrane separator between anode and cathode. The system was sealed using 0.5 mm thick expanded PTFE gaskets on each side of the membrane, between the graphite flow plates. The window of the gaskets, yielding the active area of the membrane, was 2.55 cm². The gaskets were then compressed to achieve ~20% compression of the carbon paper by torquing the cell bolts to 10 in lbs⁻¹. Two sections of Swagelok PFA tubing were connected to the respective custom polypropylene flow field using ⅛″ Swagelok fittings with each piece of tubing terminating in the PFA electrolyte reservoir (10 mL jar, Savillex). One of the sections of PFA tubing contained a portion of Masterflex Norprene tubing to be placed in the peristaltic pump head.

For each test, the reservoirs were loaded with FcN and MV as cathode and anode materials, respectively (8 mL of each, 10 mL for the 1000 cycle test, 10 mM in 0.5 M KPF₆/acetonitrile solution). These electrolyte solutions were flowed continuously for the duration of the test at a flow rate of 10 mL min⁻¹. To pretreat the membrane, no electrochemical cycling was performed during the first hour of electrolyte flow. After pretreatment, the battery was galvanostatically charged and discharged at a rate of 10 mA and −10 mA (3.9 mA cm⁻², −3.9 mA cm⁻²) respectively through 100 cycles (with exception of the 1000 cycle studies) using a Biologic VSP potentiostat with 1.5 V and 0.5 V as upper and lower voltage limits. After the last charge/discharge cycle, solutions were immediately collected for post-cycling crossover analysis through cyclic voltammetry. All tests were performed in an inert atmosphere glovebox (Ar, ≤0.5 ppm O₂ and ≤0.5 ppm H₂O).

Following synthesis, electrochemical characterization of the standard electrolytes was conducted to prove the reversibility of redox chemistry and rapid kinetics for the RFB cell. Scan rate-dependent CVs were performed with a 10 mM solution in triplicate with a glassy carbon working electrode (3 mm diameter active area), Ag/Ag⁺ quasi-reference electrode, and a platinum wire counter electrode. Acetonitrile with 0.5 M KPF₆ was used as the solvent and supporting electrolyte respectively, mimicking battery cycling electrolytes. Rates of 5, 10, 25, 50, 75, 100, 200, 300, 400, and 500 mV s⁻¹ were used. Ferrocene was doped in the post-rate dependence solutions as an internal standard and all potentials were referenced versus Fc⁰/Fc⁺. Anodic and cathodic peak currents were measured, and their ratios were plotted for both the FcN and MV electrode species. Both electrochemical species show excellent reversibility under these conditions.

The diffusion coefficients for FcN and MV were calculated through the rewritten Randles-Ševčik equation (equation 7, equation solved for D), where D is the diffusion coefficient, iₚ is the peak current, n is the number of electrons transferred (1 for both FcN and MV), A is the electrode surface area (0.0706 cm²), C is the concentration of analyte in solution (10⁻⁵ mol cm⁻³), and v is the scan rate (0.1 V s⁻¹). Diffusion coefficient results for MV (D=8.49×10⁻⁶ cm² s⁻¹) and FcN (D=9.59×10⁻⁶ cm² s⁻¹) are in good agreement with previously published literature.

$$D = {( \frac{{t}_{p}}{( 2.69 \times {10}^{6} ) {n}^{3 / 2} {ACv}^{3 / 2}} )}^{2} \qquad ( 7 )$$

Probing the extent of crossover in NARFBs requires a standard, reproducible RFB cell configuration with minimal electrolyte interaction across charge states. For such a purpose, a zero-gap flow cell was selected as a test system. Robust, well-characterized electrolytes were selected, with (ferrocenylmethyl)trimethylammonium (“FcN”) selected as the cathode and methyl viologen (“MV”) selected as the anode in a one-to-one equivalent ratio across the membrane (only 1 electron accessed in MV). These were ion-exchanged and used during cycling in their hexafluorophosphate (PF₆⁻) counter ion form.

These electrolytes were chosen as standards for the test system due to their desirable thermodynamic and kinetic properties without deleterious interaction between radical FcN and MV species in the charged states. In addition, the potential difference between redox couples of MV (−0.83 V vs Fc⁰/Fc⁺) and FcN (0.22 V vs Fc⁰/Fc⁺) provides a low cell voltage (1.05 V) which avoids extreme potentials and any resulting electrochemical degradation of the solvent and side reactions with the supporting electrolyte which would skew RFB cell metrics and post-cycling analysis. By selecting these electrolytes, it was rationalized that crossover would be the main contributor governing capacity fade in the RFB cells. Crossover can then be quantified by using post-cycle cyclic voltammetry (CV) by analyzing peak current heights and comparing to a calibration curve to provide reliable concentration measurements.

Methyl viologen dihexafluorophosphate was synthesized as follows. Methyl viologen dichloride was first synthesized. 4,4′-bipyridine (50.0 g, 320 mmol) was reacted with chloroacetic acid (81.7 g, 860 mmol) in dimethyl formamide (DMF, 300 mL) under constant stirring (700 rpm) at 140 °C for 24 hours. The precipitate formed was then washed with DMF (3×100 mL), followed by DCM (3×100 mL) and dryed under vacuum for 24 hours at 40 °C. The resulting methyl viologen dichloride was then ion exchanged by adding 10 mL of a saturated solution of ammonium hexaflurophosphate in water dropwise. The mixture was then stirred for 24 hours at room temperature. The resulting precipitate was collected by filtration, washed 3 times with DI water, and dried under vacuum for 24 hours at 40 °C.

(ferrocenylmethyl)trimethylammonium hexafluorophosphate as synthesized as follows. (Ferrocenylmethyl)trimethylammonium chloride (FcNCl) was first synthesized. (ferrocenylmethyl)dimethylamine (20.0 g, 82.3 mmol) was combined with chloromethane (1 M in tert-butylether, excess) in a round bottom flask containing 100 mL of acetonitrile under an inert atmosphere (nitrogen purged). The resulting precipitate was collected by filtration with a fine-grained frit glass filter and washed 3 times with 100 mL of diethyl ether. The product was then dried under vacuum for 24 hours at 40 °C. Approximately 10 g of the resulting FcNCl was dissolved in 200 mL DI water and ion exchanged by adding 10 mL of a saturated solution of ammonium hexaflurophosphate in water dropwise. The mixture was then stirred for 24 hours at room temperature. The resulting precipitate was collected by filtration, washed 3 times with DI water, and dried under vacuum for 24 hours at 40 °C.

RFB cells were assembled in triplicate, with six replicates for TMA-PE-4 with TMA-PE-x membranes with varied cationic contents to understand the effect of cationic concentration on cell performance. FAPQ was also tested as a commercial standard, given its literature precedent in SOM based NARFB cells. In all cases, a charge/discharge current of 10 mA was used with voltage cutoffs of 1.5 and 0.5 V. Battery cycling analysis and statistics can be found in Table 2.

TABLE 2

| | IEC | | | Avg Capacity | Total | | |
|---|---|---|---|---|---|---|---|
| | (Theo) | Catholyte | Anolyte | Retention/ | Capacity | | Avg |
| | (mmol | Crossover | Crossover | Cycle | Fade | Resistance | Efficiency |
| Membrane | I⁻/g) | (%)^{a} | (%)ª | (%)ª | (%)ª | (Ω)ª | (%)ª |
| FAPQ | n.d. | 20 ± 1 | 32 ± 2 | 99.64 ± 0.02 | 30 ± 1 | 565 ± 1 | 98.7 ± 0.1 |
| TMA- | 1.84 | 30 ± 6 | 32 ± 6 | 99.52 ± 0.09 | 38 ± 1 | 539 ± 4 | 96.5 ± 1.4 |
| PE-2 | | | | | | | |
| TMA- | 1.53 | 20 ± 4 | 19 ± 3 | 99.68 ± 0.06 | 27 ± 4 | 546 ± 8 | 97.9 ± 0.8 |
| PE-3 | | | | | | | |
| TMA- | 1.31 | 9 ± 1^{b} | 7 ± 3^{b} | 99.86 ± 0.07^{b} | 12 ± 5^{b} | 545 ± 5^{b} | 98.9 ± 0.5^{b} |
| PE-4 | | | | | | | |
| TMA- | 1.14 | 5 ± 2 | 7 ± 5 | 99.84 ± 0.01 | 14 ± 2 | 556 ± 4 | 97.0 ± 0.6 |
| PE-5 | | | | | | | |
| TMA- | 1.02 | 1 ± 2 | 1 ± 3 | 100.02 ± 0.04 | −1 ± 4 | 587 ± 9 | 97.0 ± 0.7 |
| PE-6 | | | | | | | |

^{a}Average values presented with standard deviation from triplicate sample data collection.
^{b}Sample data collection was performed six times for these values.

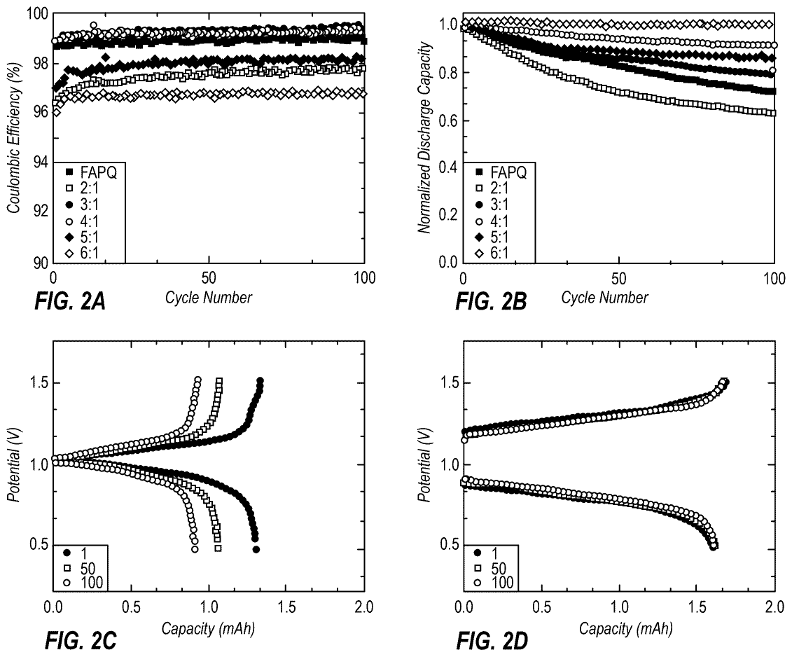

All of the RFB cells employing TMA-PE-x membranes, except TMA-PE-2, outperformed FAPQ in all cycling data and crossover percentages. Measured Coulombic efficiencies in all cases of the RFB cells studied were acceptable given non-interaction between electrolytes, with all systems above 95%, as shown in FIG. 2A. The data shows a pyramid-like trend in Coulombic efficiency, increasing from TMA-PE-2 up to a maximum with TMA-PE-4 and then decreasing again down to the low for TMA-PE-6 (see Table 2). Further, cycling data showed a generally decreasing capacity fade through 100 cycles with decreasing cationic content of the polymer from 38±1% in the cells containing TMA-PE-2 to −1±4% for TMA-PE-6 (FIG. 2B). These measurements correspond to an average capacity retention per cycle of 99.52±0.02% and 100.00±0.04% for TMA-PE-2 and TMA-PE-6, respectively. Comparing results to the FAPQ comparative example membrane, the capacity of the FAPQ RFB decreases after 50 and 100 cycles, (FIG. 2C) while the capacity of the TMA-PE-6 cell shows no change after 100 cycles (FIG. 2D). These capacity fade and retention statistics achieved in TMA-PE-6 in an asymmetric NARFB cell are particularly advantageous in the field for system stability and crossover mitigation. Surprisingly, the capacity fade trend was inverted for TMA-PE-4 and TMA-PE-5 through 100 charge/discharge cycles (FIG. 2B). This may be attributed to the greater initial capacity fade for TMA-PE-5. However, the average capacity retention per cycle from cycle 25 to 100 for these membranes is similar in TMA-PE-4 (99.90±0.03%) compared to TMA-PE-5 (99.92±0.01%). The crossover analysis, discussed further below, also shows a lower average crossover in TMA-PE-5; therefore we attribute the initial capacity fade to mechanisms other than crossover.

In RFBs, minimization or prevention of crossover must be balanced with membrane conductivity in order to allow for efficient charge transport. While capacity fade decreased with decreasing cationic content of TMA-PE-x, lower efficiencies and higher resistances were also observed, as shown in Table 2. These data suggest that further decreasing the cationic content will lead to sluggish system performance due to reduced counterion transport.

Post-cycling electrolyte crossover analysis was performed, through cyclic voltammetry. Electrolyte concentrations were determined through diagnostic analysis performed through CV pre- and post-cycling. The Randles-Sevcik equation shows that the current peak height (in mA) is directly proportional to the concentration of redox-active material in the solution. Thus, by scanning before and after cycling, the percent crossover of anolyte in the catholyte solution and catholyte in the anolyte solution can be determined after obtaining concentration standard current values from a calibration curve.

In particular, CVs were performed on the anolyte and catholyte solutions before and after cycling, with a 10 mM solution in triplicate with a glassy carbon working electrode, Ag/Ag⁺ wire quasi-reference electrode, and a platinum wire counter electrode. A scan rate of 100 mV s⁻¹ was used in all cases with a 1.5 V window (~−1.05 V to 0.45 V vs Fc⁰/Fc+). The Randles-Ševčik equation (8) below was used to determine anolyte and catholyte crossover concentrations, where iₚ is the peak current, n is the number of electrons transferred, F is Faraday's constant, A is the surface area of the electrode, C is the concentration of the analyte, v is the scan rate, D is the diffusion coefficient, R is the gas constant, and T is the temperature of the solution.

$${i}_{p} = 0.4463 {nFAC ( \frac{nFvD}{RT} )}^{\frac{3}{2}} \qquad ( 8 )$$

Given that peak current, iₚ, is directly proportional to the concentration of analyte in solution, C, obtaining a calibration curve of peak currents corresponding to known concentrations allows for the quantification of unknown electrolyte concentrations in pre/post cycling solutions.

Membrane resistance measurements were collected by taking post-RFB cell cycling membranes and placing them in an H-cell. Data was generated using a two-electrode cell with graphite rods as electrodes in conjunction with a CH Instruments potentiostat. The iR compensation of the software was selected; the resistance portion (in ohms) was taken as the membrane resistance. Measurements were taken in 0.5 M KPF₆ in acetonitrile, the same supporting electrolyte/solvent combination which was used in CV and in the RFB cells, for consistency.

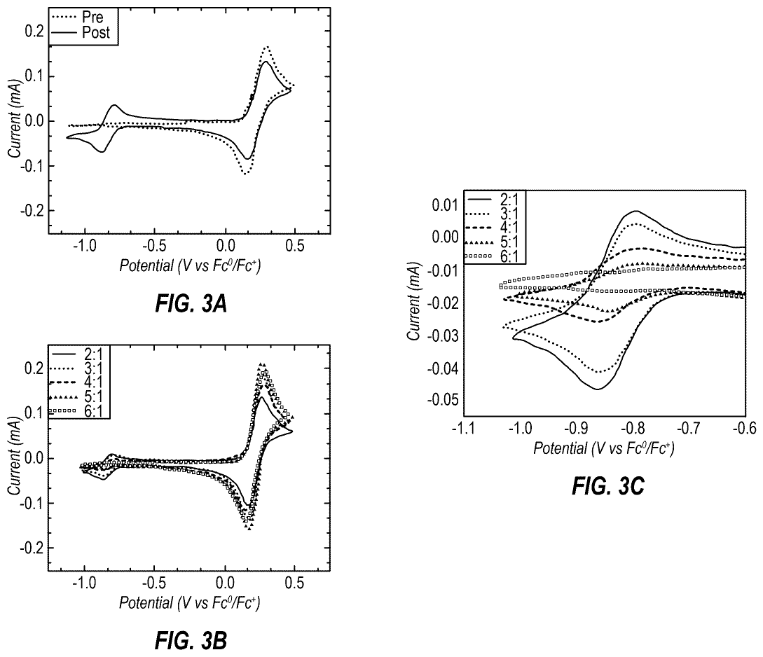

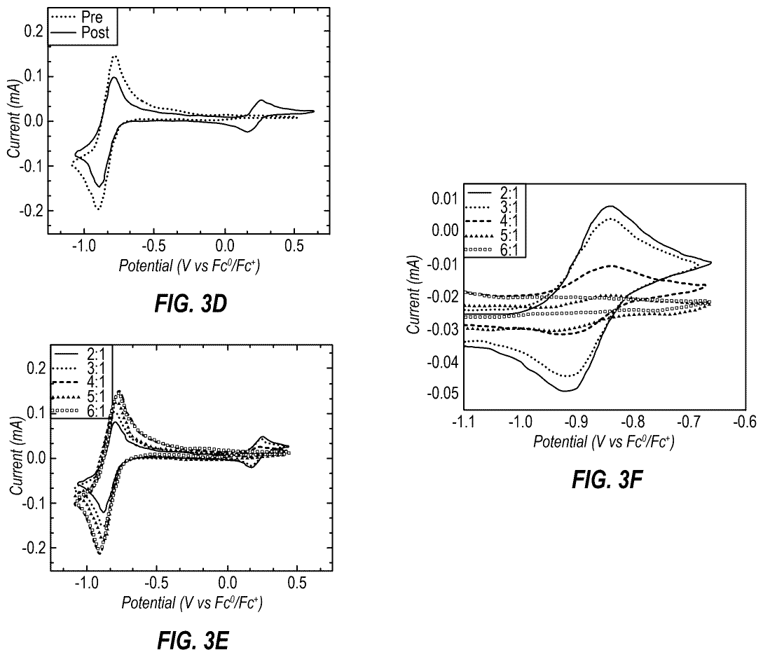

In the RFB cells containing the FAPQ membrane, a large characteristic crossover redox peak couple appears in the post-cycling solution, showing a 20±1% crossover of catholyte to the anode chamber (cathodic peak FcN, 0.22 V vs Fc⁰/Fc⁺) and 32±2% anolyte to the cathode chamber (anodic peak MV, −0.83 V vs Fc⁰/Fc⁺), as shown in FIGS. 3A and 3D, respectively. The TMA-PE-x membranes demonstrated a range of crossover values, with TMA-PE-2 showing comparable crossover to FAPQ (30±6% catholyte and 32±6% anolyte) to near non-detectable for TMA-PE-6 (1±2% catholyte and 1±3% anolyte). Clear trends were observed wherein the magnitude of the crossover redox peaks in the catholyte (FIGS. 3B and 3C) and anolyte solutions (FIGS. 3E and 3F) were correlated to the cationic content of the membranes. It is important to note that no electrolyte degradation was observed by CV.

The CV data obtained corroborate the observed cell capacity fade and retention data. It is reasoned that performance loss in the tested systems can be mostly attributed to crossover given the similarity in the percentage of crossover to the fade in discharge capacity for each membrane. However, as mentioned previously, crossover is not the only contributor to capacity fade, given the inconsistency with the TMA-PE-5 data showing higher capacity fade than crossover. Thus, the CV pre- and post-cycling analysis are relied on to provide the most convincing evidence of crossover mitigation observed with decreasing cationic content in the tested TMA-PE-x membranes.

The two most compelling results from these data are 1) the understanding of how modulation of the cationic content affects crossover, and 2) the outstanding performance of TMA-PE-6 after 100 charge/discharge cycles. Of note, in two of the three conducted trials for TMA-PE-6, no crossover was detectable via CV, with minor redox peaks appearing in the crossover region of the third trial. Near-complete inhibition of crossover by an ion-exchange membrane in non-aqueous systems has never been demonstrated to the knowledge of Applicant. With this result in hand, these materials were further studied to include a long-term cycling analysis to probe the stability of the TMA-PE-6 system through 1000 charge/discharge cycles.

### Example 2

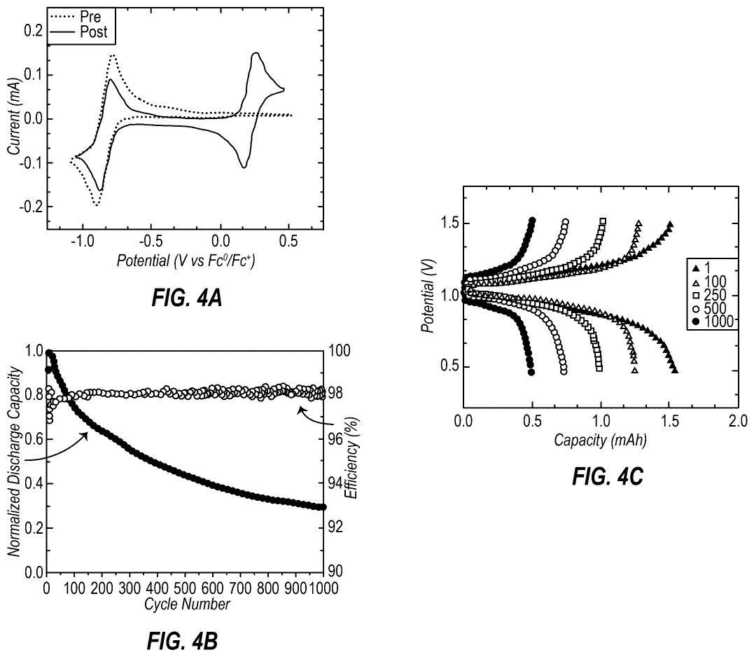

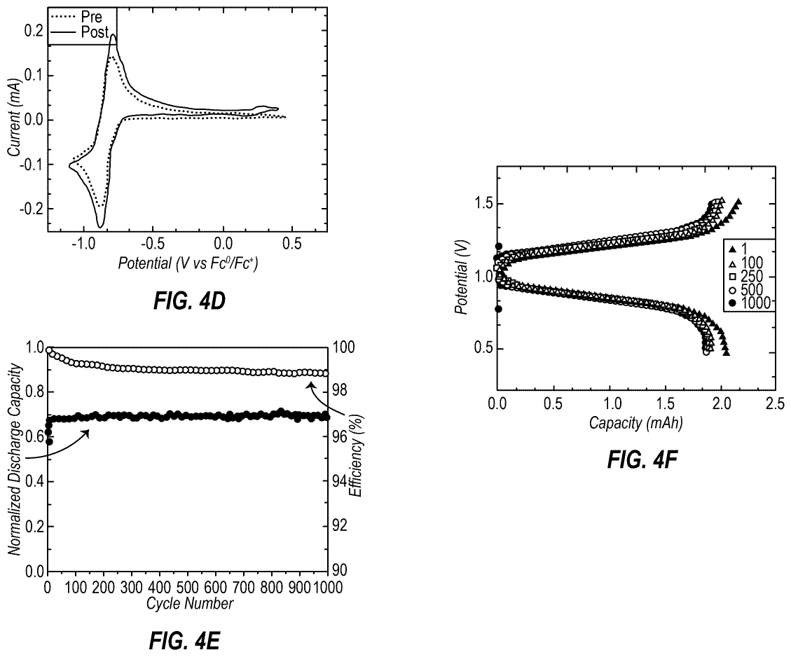

To investigate the long-term crossover resistance and cycling stability of TMA-PE-6 in comparison with FAPQ, 1000 cycle RFB tests were performed. A marked capacity fade was observed for FAPQ through 1000 cycles, largely due to crossover as evidenced by the post-cycling anolyte CV in which crossover reached 50% (see FIG. 4A). Further, the capacity faded to below 50%, and the efficiency remained stable (see FIG. 4B). The theoretical maximum capacity fade due to crossover is 50% and since the capacity fade of the system is beyond 50% other degradation mechanisms such as self-discharge, species concentration, and/or volumetric imbalance could have significantly contributed to the capacity fade of this system. Capacity fade beyond 50% could have also resulted from rapid crossover during discharge, as charged electrolyte species are no longer available for discharge.

In contrast, the RFB cell containing TMA-PE-6 maintained stable cycling through the full test, showing only 11% crossover for the catholyte into the anolyte chamber (FIG. 4D) and 12% crossover for the opposing anolyte into the catholyte resulting in only 12% capacity fade over the 1000 cycle test (FIG. 4E). The average capacity retention per cycle of this cell was 99.99%, with less than 0.01% fade per cycle, compared to 0.1% fade per cycle for FAPQ, a factor of 10× improvement. The crossover results for TMA-PE-6 after 1000 cycles improve upon even the 100-cycle data for the FAPQ RFB. These results are promising as an asymmetric SOM-based NARFB cell with stability through 1000 cycles has not previously been demonstrated. It is also important to note that TMA-PE-6 cycled for over twice the wall-clock time as FAPQ (~378 hrs vs. ~166 hrs, respectively) with the same charge/discharge current and potential limitations.

Similar to the initial discharge capacity fade observed for TMA-PE-5, which led to an inversion of the data in the 100 cycle experiments, Applicant noted an initial fade in the 1000 cycle TMA-PE-6 experiment. However, cycles 200 through 1000 show average capacity retention of over 99.995% per cycle (compared to 99.955% average for cycles 1 through 200). This phenomenon is shown in the voltage vs capacity plot for TMA-PE-6 (FIG. 4F) with the change in capacity observed mostly after 100 cycles, with minor changes in capacity at 250 cycles, and no further decrease in capacity after 500 and 1000 cycles. Conversely, the comparative example standard, FAQP, demonstrated significant and progressive capacity fade at 100, 250, 500, and 1000 cycles (FIG. 4C) The extreme cycling stability of TMA-PE-6 shows the possibility of developing robust RFB systems utilizing such a material as the separating membrane.

Crossover is a major mechanism in battery hysteresis in NARFB systems, but much remains to be understood and addressed. The present disclosure demonstrates TMA-functionalized PE copolymers as effective membranes for mitigating electrolyte crossover in NARFBs. RFB cycling and CV data reported herein lead to the conclusion that electrolyte crossover and capacity fade in a prototype RFB cell is proportional to the cation content of the membrane separator, which was modulated by varying the COE:CTMA ratio in a ROMP/hydrogenation sequence. By decreasing the cationic content of TMA-PE-x, crossover is effectively mitigated until nearly eliminated in the TMA-PE-6 example (1±2% catholyte and 1±3% anolyte crossover detected through 100 cycles). Further, TMA-PE-6 shows impressive cycling stability and crossover resistance through 1000 charge/discharge cycles. To knowledge of Applicant, TMA-PE-6 demonstrates the highest resistance to crossover to date, paving the way for eventual commercial utilization.

Investigating other membrane properties such as the ionic group character, membrane thickness, and crosslinking may enhance the selectivity of this class of membranes while providing greater conductivity and low resistance. Combining TMA-PE-x membranes with designer electrolytes to improve the RFB cell voltage and thus theoretical energy density are also contemplated.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” “involves,” “contains,” etc.), and similar terms as used herein, including within the claims, shall be inclusive and/or open-ended, shall have the same meaning as the word “comprising” and variants thereof (e.g., “comprise” and “comprises”), and do not exclude additional un-recited elements or method steps, illustratively. Unless defined otherwise, all technical and scientific terms used herein have the same meaning as commonly understood by one of ordinary skill in the art to which the present disclosure pertains.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used herein, the term “between” includes any referenced endpoints. For example, “between 2 and 10” includes both 2 and 10.

Some ranges may be disclosed herein. Additional ranges may be defined between any values disclosed herein as being exemplary of a particular parameter. All such ranges are contemplated and within the scope of the present disclosure.

The phrase “free of” or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

Disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure. Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Accordingly, the present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. A non-aqueous redox flow battery (NARFB) comprising:
a pair of stationary electrodes including a first electrode and a second electrode;
a non-aqueous anolyte which is cycled through the NARFB, so as to contact the first electrode in a first cell portion;
a non-aqueous catholyte which is cycled through the NARFB, so as to contact the second electrode in a second cell portion;
wherein the first and second cell portions containing the anolyte and catholyte respectively are separated from one another by a membrane, wherein the membrane comprises a cation functionalized polyethylene or other polymeric membrane for mitigating crossover of the anolyte into the second cell portion and for mitigating crossover of the catholyte into the first cell portion.

2. The non-aqueous redox flow battery (NARFB) of claim 1, wherein the cation functionalized polyethylene or other polymeric membrane comprises a polyethylene or other polymeric membrane functionalized with trimethylammonium (“TMA”), an imidazole, a phosphonium, triaminocyclopropenium, and/or a quaternary ammonium other than TMA, having alkyl groups having from 1 to 20 carbons.

3. The non-aqueous redox flow battery (NARFB) of claim 1, wherein the catholyte comprises (ferrocenylmethyl)trimethylammonium (“FcN”), a phenathiazine, and/or a derivative of 2,2,6,6-tetramethylpiperidine-1-oxyl (“TEMPO”).

4. The non-aqueous redox flow battery (NARFB) of claim 1, wherein the anolyte comprises methyl viologen (“MV”), another viologen, a quinone, and/or a pyridinium.

5. The non-aqueous redox flow battery (NARFB) of claim 1, wherein the catholyte comprises (ferrocenylmethyl)trimethylammonium (“FcN”) hexafluorophosphate and the anolyte comprises methyl viologen (“MV”) hexafluorophosphate.

6. The non-aqueous redox flow battery (NARFB) of claim 1, wherein the cation functionalized polyethylene or other polymeric membrane comprises a quaternary ammonium functionalized polyethylene or isotactic polypropylene membrane, wherein the quaternary ammonium functionalized polyethylene or isotactic polypropylene membrane is optionally formed from copolymerized cycloalkene polymerizable components.

7. The non-aqueous redox flow battery (NARFB) of claim 6, wherein the copolymerized cycloalkene polymerizable components comprise cis-cyclooctene (“COE”) and a trimethylammonium or other quaternary ammonium substituted cyclooctene polymerizable component.

8. The non-aqueous redox flow battery (NARFB) of claim 7, wherein the trimethylammonium substituted cyclooctene polymerizable component comprises (Z)—N,N,N-trimethyl-1-(1-methylcyclooct-4-en-1-yl)methanaminium iodide (“CTMA”)).

9. The non-aqueous redox flow battery (NARFB) of claim 6, wherein the copolymerized cycloalkene polymerizable components comprise a quaternary ammonium substituted cycloalkene polymerizable component and a neutral or unsubstituted cycloalkene polymerizable component in a molar ratio of from 1:1 to 1:10.

10. The non-aqueous redox flow battery (NARFB) of claim 6, wherein the copolymerized cycloalkene polymerizable components comprise a quaternary ammonium substituted cycloalkene polymerizable component and a neutral or unsubstituted cycloalkene polymerizable component in a molar ratio of from 1:2 to 1:6.

11. The non-aqueous redox flow battery (NARFB) of claim 6, wherein the copolymerized cycloalkene polymerizable components comprise a quaternary ammonium substituted cycloalkene polymerizable component and a neutral or unsubstituted cycloalkene polymerizable component in a molar ratio of from 1:3 to 1:6.

12. The non-aqueous redox flow battery (NARFB) of claim 1, wherein at least one of the non-aqueous anolyte or the non-aqueous catholyte comprise an acetonitrile organic solvent, a propylene carbonate organic solvent and/or a dimethylformamide (“DMF”) organic solvent.

13. A non-aqueous redox flow battery (NARFB) comprising:
a pair of stationary electrodes including a first electrode and a second electrode;
a non-aqueous anolyte which is cycled through the NARFB, so as to contact the first electrode in a first cell portion;
a non-aqueous catholyte which is cycled through the NARFB, so as to contact the second electrode in a second cell portion;
wherein the first and second cell portions containing the anolyte and catholyte respectively are separated from one another by a membrane, wherein the membrane comprises a quaternary ammonium functionalized polyethylene or isotactic polypropylene membrane for mitigating electrolyte crossover of the anolyte into the second cell portion and for mitigating crossover of the catholyte into the first cell portion;
wherein at least one of the non-aqueous anolyte or the non-aqueous catholyte optionally comprise an acetonitrile organic solvent, a propylene carbonate organic solvent and/or a dimethylformamide (“DMF”) organic solvent.

14. The non-aqueous redox flow battery (NARFB) of claim 13, wherein the battery exhibits greater than 99% average capacity retention per cycle.

15. The non-aqueous redox flow battery (NARFB) of claim 13, wherein the battery exhibits at least 50% total capacity retention through 1000 charge/discharge cycles.

16. The non-aqueous redox flow battery (NARFB) of claim 13, wherein the catholyte comprises (ferrocenylmethyl)trimethylammonium (“FcN”) a phenathiazine, and/or a derivative of 2,2,6,6-tetramethylpiperidine-1-oxyl (“TEMPO”).

17. The non-aqueous redox flow battery (NARFB) of claim 13, wherein the anolyte comprises methyl viologen (“MV”) another viologen, a quinone, and/or a pyridinium.

18. The non-aqueous redox flow battery (NARFB) of claim 13, wherein the quaternary ammonium functionalized polyethylene or isotactic polypropylene membrane comprises quaternary ammonium functionalized polyethylene, optionally formed from copolymerized cycloalkene polymerizable components, wherein the copolymerized cycloalkene polymerizable components comprise cis-cyclooctene (“COE”) and a quaternary ammonium substituted cyclooctene polymerizable component.

19. The non-aqueous redox flow battery (NARFB) of claim 13, wherein the quaternary ammonium functionalized polyethylene or isotactic polypropylene membrane is formed from copolymerized cycloalkene polymerizable components, wherein the copolymerized cycloalkene polymerizable components comprise a trimethylammonium or other quaternary ammonium substituted cycloalkene polymerizable component and a neutral or unsubstituted cycloalkene polymerizable component in a molar ratio of from 1:1 to 1:10.

20. The non-aqueous redox flow battery (NARFB) of claim 13, wherein the quaternary ammonium functionalized polyethylene or isotactic polypropylene membrane membrane is formed from copolymerized cycloalkene polymerizable components, wherein the copolymerized cycloalkene polymerizable components comprise a trimethylammonium or other quaternary ammonium substituted cycloalkene polymerizable component and a neutral or unsubstituted cycloalkene polymerizable component in a molar ratio of from 1:2 to 1:6.
